(19) United States
(12) Patent Application Publication
(10) Pub. No.: US 2014/0089171 A1
(43) Pub. Date: Mar. 27, 2014

(54) INSTANTANEOUS MULTI-CAST FUNDING AT POINT OF SALE

(71) Applicant: EBAY INC., San Jose, CA (US)

(72) Inventor: Saumil Ashvin Gandhi, Sunnyvale, CA (US)

(73) Assignee: eBay Inc., San Jose, CA (US)

(21) Appl. No.: 13/625,536

(22) Filed: Sep. 24, 2012

(51) Int. Cl. G06Q 20/22

(52) U.S. Cl. 705/39

(57) ABSTRACT

A service provider communicates to potential funders, over social networks they subscribe to, a funding request to fund a user's purchasing of an item(s) the user found during online or offline shopping, based on a funders' profile the user previously created. The funders' profile contains identifiers of potential funders, social networks, and any restrictions in communicating the funding request. At the time of requesting the service provider for the multi-cast broadcasting, the user may set the time limit for receiving funds, modify the funders' profile, and transmit the information of the desired item(s) via either a user's device or a merchant device. Before or when the funding time expires, the user may extend the time. When sufficient fund arrives at the user's account, the user is notified and the service provider proceeds with the payment transaction at the user's request to complete the purchase.

### BACKGROUND

1. Field of the Invention

The present invention generally relates to procuring instantaneous funding for a purchase at point of sale, and more particularly, through timed multi-cast funding request to potential funders.

2. Related Art

When shopping at an online or offline store or other physical point of sale location, a consumer is typically provided numerous options for payment, such as cash, check, debit card, and credit card. However, as more and more consumers are using smart phones, they may be less inclined to pay with such funding sources as a physical wallet or purse. Furthermore, such funding sources may be unsafe or unsecure, e.g., possibility of a consumer losing cash, credit cards or check forgeries.

Payment providers, such as PayPal, Inc. of San Jose, Calif., offer payment services to consumers with added security. As such, an increasing number of consumers are using third party payment providers to make payments. Such a trend is especially prevalent with online transactions. The third party payment providers can be easily accessed from a device such as PCs, smart phones, or tablets via an installed application therein, and used for payment from the accounts of customers with them.

At times, however, consumers feel frustration and disappointment during shopping, whether online or offline, when they find there remains insufficient money in their accounts, the accounts with third party payment providers, to purchase an item(s) they sighted and desired. The item(s) may not wait, either on the store shelves or on the online catalog, for the consumers to return with sufficient funds. This may result in not only inconvenience, dissatisfaction on the part of the consumers, but loss of sales on the part of the merchants.

Therefore, a need exists to provide consumers a way to procure or borrow sufficient funds within a relatively short period of time of shopping to enable the consumers to gratify their instantaneous purchase needs.

### BRIEF DESCRIPTION OF THE FIGURES

FIG. 1 is a flowchart showing a process a user or a buyer performs in setting up or modifying a funders' profile with a user account with a service or payment provider according to one embodiment;

FIG. 2 is a flowchart showing a process, the user performs to sending a multi-cast request to the payment provider for communicating a funding request to potential funders via a multi-cast broadcasting for purchasing an item(s) the user desires, according to one embodiment;

FIG. 3 is a flowchart showing a process a payment provider performs in communicating the funding request to potential funders via a multi-cast broadcasting, based on the funders' profile created in FIG. 1, according to one embodiment;

FIG. 4 is a flowchart showing a process a user performs in making a purchase through the payment provider after sending a multi-cast request to the payment provider in FIG. 2, according to one embodiment;

FIG. 5 is block diagram of a networked system suitable for implementing the process described herein according to an embodiment; and

FIG. 6 is a block diagram of a computer system suitable for implementing one or more components in FIG. 4 according to one embodiment.

### DETAILED DESCRIPTION

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

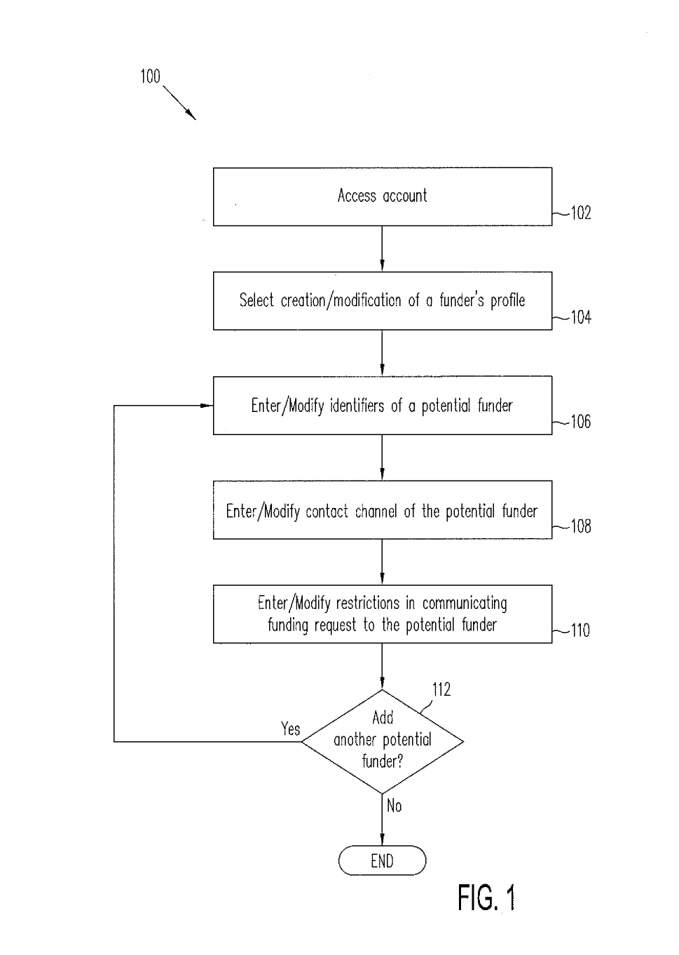

FIG. 1 is a flowchart showing a process 100 a user or a buyer performs in setting up or modifying a funders' profile with a user account with a service or payment provider, such as PayPal, Inc. of San Jose, Calif., according to one embodiment. A funder may be defined as someone who potentially or actually funds a purchase for or on behalf of the user. The user may access, at step 102, the account through a user device, such as a PC, smart phone, tablet, or other suitable device. Accessing may include entering any requested identification and/or authentication information, such as a user name, email address, name, phone number, password, PIN, pass code, etc.

Once the user has been authenticated, the user may be directed to a home page of the payment provider or user account. On the page, there may be an option to access or create a funders' profile. The option may be presented as a tab, button, or link the user can select. To create the funders' profile by the process 100, at step 104, the user taps or clicks on the tab, button, or link on the user device through a touch screen or mouse.

The user may then see a funders' profile set up screen on the user device having instructions and/or fields for the user to select or enter information into. Examples of requested information include, but are not limited to, an identifier of each potential funder, any social network services the particular potential funder and/or the user subscribes to, and any restrictions in communicating a funding request to that particular potential funder.

At step 106, the user enters or modifies identifiers of a potential funder. The identifier can be a name, an email address, a mobile phone number, or other information that identifies the potential funder. The type of identifiers may be specified by the payment provider in one embodiment. The user may enter the identifiers in different ways, including through a user contact or address book on the user device, through a user's social network, through manually entering the identifier onto a field via a device keyboard or keypad, or speaking the identifier into a device microphone.

At step 108, the user may add or modify any contact channels through which the particular potential funder can be reached by the payment provider. The contact channels include, but are not limited to, emails, phones, bank accounts, PayPal accounts of the potential funder, and social network services the potential funder subscribes to. Examples of the social network services include, but are not limited to, facebook, tweet (or twitter), linkedin, Google+, or other SMSs(small message systems).

At step 110, the user may add/modify any restrictions in communicating, by the payment provider, a funding request on behalf of the user to a particular potential funder. Examples of restrictions include restrictions on the kinds of items, price ranges of items, and names of sellers/merchants, for which the funding request should not be communicated to a particular potential funder, restrictions on time zones of a year during which the funding request should not be communicated, or restrictions on messages to be communicated together with the funding request.

The restrictions may further include restrictions on total monthly or yearly funding amount a particular potential funder can make so that if the total funding amount exceeds the preset maximum, the funding request should not be communicated to that particular potential funder.

The user may enter or modify the restrictions for each potential funder either by tapping, clicking on tabs, buttons on the screen of a user device, typing into fields through a device keyboard or keypad, or speaking the restrictions into a device microphone. The types of restrictions and individual choices in a given potential funder may be preset and provided for the user to select in one embodiment, or the user may create/add restrictions in another embodiment.

The user can view the information entered at each step, and when no more information is to be added for a particular potential funder, the user is notified to confirm or modify, if desired, any information. Note that one or more of the steps herein can be combined with one or more steps, omitted, and/or performed in a different sequence. Once the information is confirmed, at step 112, the user is given a choice to add another potential funder in the funders' profile. If the user chooses to add another potential funder, the user may repeat the process from step 106 until the user has finished adding all potential funders she or he wants. After finishing the process, the data of the funders' profile are stored or associated or linked with the user account on the payment provider.

As such, a funders' profile can be created or modified with information that enables a payment provider to communicate a funding request via a multi-cast broadcasting, upon receiving a multi-cast request from a user, to all potential funders according to any restrictions initially set up or subsequently modified by the user.

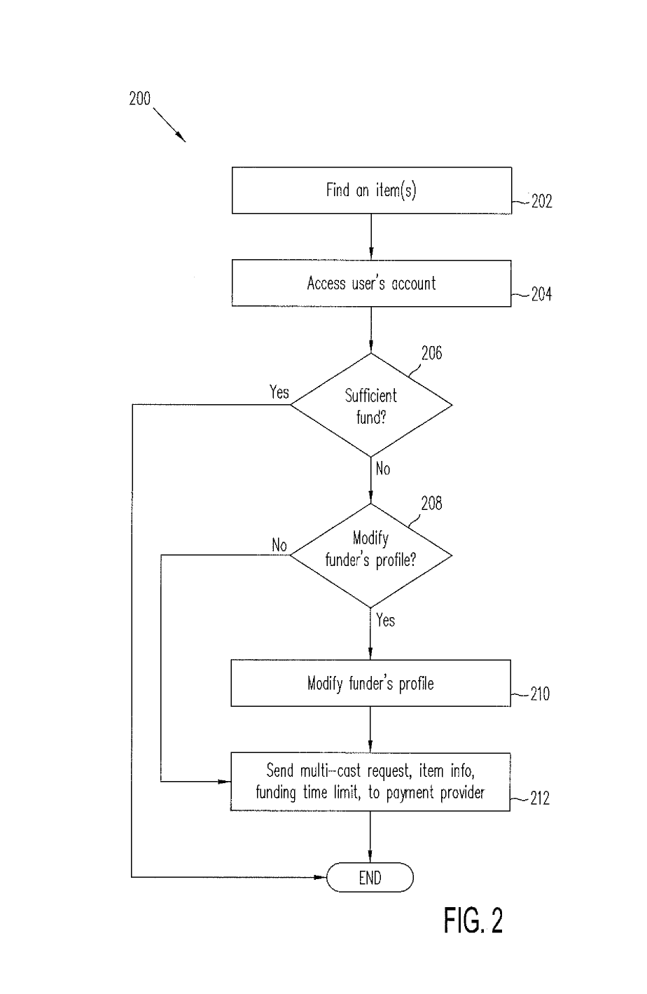

FIG. 2 is a flowchart showing a process the user performs to send a multi-cast request to the payment provider for communicating a funding request to potential funders for purchasing an item(s) the user desires via the payment provider's a multi-cast broadcasting, according to one embodiment. To process a payment transaction through the payment provider, the merchant, whether having an online or offline store, may be required to have its own account with the payment provider.

At step 202, the user finds an item(s) that she or he desires to purchase. This may be at a physical store, online, or through a mobile app. For example, the user may see a desired item at a store and scan or otherwise capture item information through a user smart phone. In another example, the user may select an item found through an online search. Information about the item, such as description, price and seller, may be conveyed to the payment provider, along with an intent to buy. This may be accomplished by placing the item in an electronic shopping cart or other means.

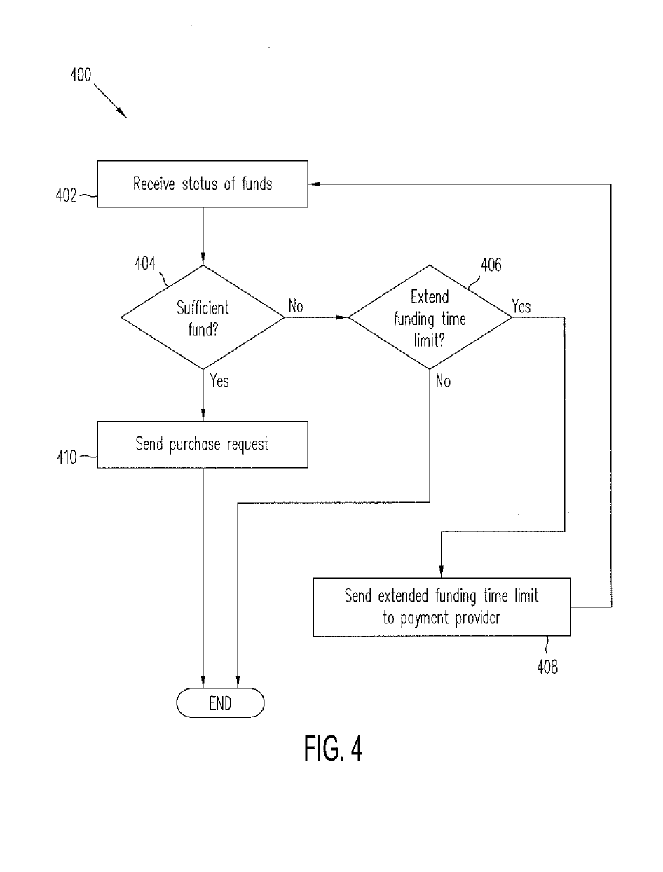

At step 204, the user accesses the user account with the payment provider through an application in the user device, such as a PC, smart phone, tablet, or other suitable device. At step 206, the user checks whether she or he has enough fund in the account to purchase the item(s). If there are sufficient funds, the user need not make a multi-cast request to the payment provider for funding. The user may directly transmit a purchase request to the payment provider together with appropriate item information for the payment provider to process the payment transaction, as described in FIG. 4 herein.

If the funds are insufficient (or even if they are sufficient), the user determines whether she or he will seek funding assistance from potential funders. In one embodiment, before sending a multi-cast request to the payment provider, the user may, at step 208, be given an option, through an application in the user device, to update or modify the funders' profile, which might have been previously set up and stored in the server of the payment provider and/or associated with the user account. If the modification is desired, the user can change, at step 210, the identifiers of the potential funders, the social network services they subscribe to, or any restrictions on individual potential funders in the same way as in the process 100 when the funders' profile was initially created or last modified. Through the modifications, the user may even choose a subset of potential funders listed in the stored funders' so that the multi-cast funding request for the particular item(s) of interest is sent only to that selected group. After finishing all modification of the funders' profile as needed, the user may send a multi-cast request to the payment provider, at step 212, asking it to communicate the user's funding request to the potential funders in accordance with the modified funders' profile.

If the user determines that there is no need to modify the funders' profile at step 208, the user may proceed directly to step 212. In either case, with or without modifying the funders' profile, the user may also transmit, at step 212, item information to the payment provider so that the payment provider may communicate it to the potential funders for their reference, subject to any restrictions in the funders' profile, and also proceed the purchase transaction when all the necessary funding is filled. The item information may include the identity, price, brand, manufacturer, seller/merchant, or even the picture of the item(s).

Further, at the same step 212, the user may determine, and transmit to the payment provider, a funding time limit for receiving funds from the potential funders after the payment provider communicates the funding request to them via multi-cast broadcasting. The time limit set by the user would be usually the expected shopping time, whether online or at an offline store, but can be longer if desired. Once receiving the funding time limit, the payment provider keeps the user's account open only for that funding time limit for receiving funds from potential funders. The funding time limit may or may not be communicated to the potential funders by the payment provider, depending on the user's choice, one of the restrictions that may be included in the funders' profile.

The transmission of the multi-cast request, the funding time limit, and the item information by the user to the payment provider may be accomplished in different ways via different devices, depending on shopping modes and merchant settings. In an online shopping mode where the user finds a desired item(s) on a merchant's online page loaded on the user's device, the merchant may or may not provide the feature of directly transmitting the multi-cast request to the payment provider. In both situations, however, the merchant may be required to have an account with the payment provider and the merchant device such as a computer server or system may be required to be linked to the payment provider by network so that the payment provider may process a payment transaction.

When the merchant itself provides the service of transmitting the multi-cast request and/or the item information for a consumer, there may be a tab or button that reads as “multi-cast request,” for instance, displayed next to or below the icon or description of the item(s) on the merchant's shopping sites. When the user simply taps or clicks on the “multi-cast request” tab or button through a touch screen or mouse, another window or menus may be popped up for the user to enter either the user's ID number or account number with the payment provider. Next, the merchant's page may request the user to set the funding time limit. When the user finishes setting the funding time limit and taps or clicks on, e.g., the “confirmation” tab or button, the merchant device such as a server may transmit directly the multi-cast request, the funding time limit, and all appropriate item information to the payment provider.

When the merchant does not support such a feature, the transmission of the multi-cast request together with the funding time limit and the item information can be accomplished, in one embodiment, through an application installed in the user's device and connected to the payment provider. In this embodiment, it is the application, not the merchant, that provides the “multi-cast request” tab or button for a particular item(s) for the user to initiate the transmission. The merchant's online shopping site may be loaded and viewed through the application. When the user taps or clicks on the “multi-cast request” tab or button provided by the application, the application may pop up another window or menu for the user to set the funding time limit. And when the user finishes setting up the funding time limit and taps or clicks on, e.g., a “confirmation” tab or button, the application may immediately transmit to the payment provider not only the multi-cast request and the funding time limit, but also item information. In this case, item information may be either directly scanned and read into the application from the descriptions of the item on the merchant's sites displayed on the user's device, or independently transferred from the merchant's server through the network. Such an application on the user device may be developed and provided either by the payment provider or a third party.

When the user is shopping in a merchant's offline store, the user may accomplish the transmission of the multi-cast request, the funding time limit, and item information in a similar way as the online shopping situation. Again, the user can access the user's account any time from the user's device to modify, if needed, the funders' profile through an installed application before the user effects the transmission. The merchant may provide the function of directly transmitting the multi-cast request and/or the item information to the payment provider in an offline store as well. For instance, a similar “multi-cast request” button may be located next to or below the item(s) on the shelves of the store. In one embodiment, a small touch screen or other means of data entry tools such as keyboard or keypad may be also located next to “multi-cast request” button. When the user presses the “multi-cast request” button, the neighboring screen may request the user to enter either the user's ID number or account number with the payment provider or the merchant using the touch screen, keyboard or keypad provided beside, or swipe/scan a user's identifier card, such as Safeway card, into the store device. Next, the screen may invite the user to enter the funding time limit. When the user finishes entering the funding time limit and presses another button or the “multi-cast request” button second time for confirmation, the multi-quest request, the funding time limit, all item information, and the user's identifier may be transmitted to the payment provider over a network directly from the merchant device such as a server or other computer systems.

When the merchant's offline store does not provide any of such features, the user can still transmit the multi-cast request together with the funding time limit and the item information through an application installed on the user device which is, in this offline shopping setting, usually a mobile phone, an iPod or a tablet such as iPad, When the user finds a desired item(s) on a shelf in the merchant's store, he may open the application on the user's device and activate the multi-cast request feature by tapping or clicking on the “multi-cast request” tab or button provided by the application. The application then may pop up another window or menu for the user to enter the funding time limit. Now the item information of the item(s) on the store shelves can be entered into the application in two different ways. In one embodiment, the user device may have a scanner and the user can scan or capture the barcode of the item(s) into the application. Item information may also be captured through the item image or other item identifier. In another embodiment, if the user device does not have such a scanning feature, the user may directly enter basic item information, such as price and the kind, into the application using a touch screen menu, keyboard or keypad on the user device. When the user finishes setting the funding time limit and entering the item information, and confirms all the data, the application may immediately transmit to the payment provider the multi-cast request, the funding time limit, the item information, and any updated funders' profile. The funders' profile may be modified by the user through the application any time before the user's final transmission of the above data.

In one embodiment, while waiting for the funds from the potential funders or at or before the expiration of the funding time, the user may extend the funding time limit, or the shopping time. In this case, the user may simply transmit a new extended funding time limit to the payment provider in the same manner described hereinbefore through either the application on user device or the merchant device. Further, if the user finds another item(s) for possible purchase while waiting for the requested funding to arrive, the user may start over the process 200 to transmit another multi-cast request and associated information for the new item(s). Funders may see a timer count down for the time remaining to fund the requested purchase transaction.

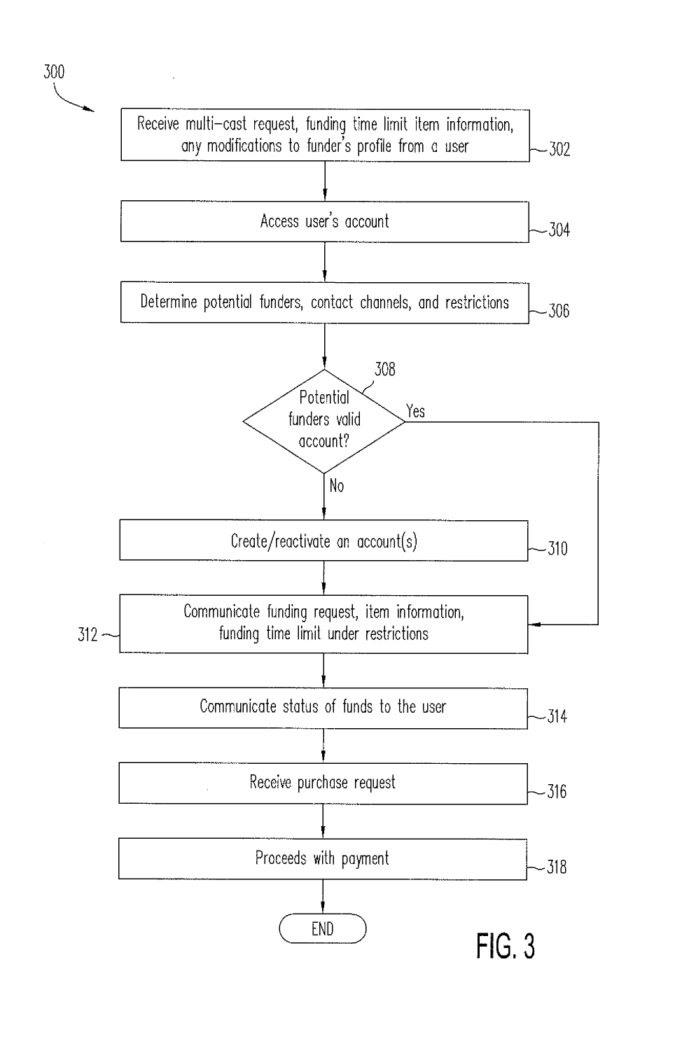

FIG. 3 is a flowchart showing a process 300 a payment provider performs in transmitting a funding request to potential funders based on the funders' profile created in FIG. 1, according to one embodiment. At step 302, the payment provider receives from a user who has a user account therewith, the multi-cast request, the funding time limit, and item information, and optionally, any modifications of the funders' profile for transmission to all or selected potential funders. Such data are wirelessly transmitted either from a user device or from a merchant device but still at the user's initiation. Such reception, by the payment provider, may happen more than once during the user's shopping time, and each time the restrictions on the multi-cast broadcasting, in addition to the item information, may not be the same as the previous one(s).

At step 304, the payment provider may access the user account and obtain account information of the user. The account information may contain user's identifiers, payment option, shipping option and address, user's past purchase history, and funders' profile previously created in the process 100. Once the account is accessed, the payment provider may determine, at step 306, to whom of the potential funders in the funders' profile it will communicate the user's funding request, over what contact channels it will contact the selected funders, and what restrictions, if any, it will apply to the individual potential funders in communicating the item information and user's funding request. The determination is made based on the funders profile initially set, as well as on any modifications to it the payment provider might have received at step 302, which will override the previous one.

In one embodiment, the payment provider may, at step 308, determine whether the potential funders, determined to be contacted at step 306, have a valid account with the payment provider. This can be done by searching an account database of the payment provider with the potential funders' information.

If the payment provider has determined at step 308 that any of the potential funders does not have a valid account with the payment provider, it may, at step 310, send to such potential funder a request for permission to create or reactivate an account and a request for certain information, such as a username, email address, phone number, credit card information, bank information, PIN, password, and/or address for that. Upon receiving the requested permission and information, the payment provider may create or reactivate an account for such a potential funder(s) at step 310.

At step 312, the payment provider may contact all potential funders determined at step 306 via the contact channels each potential funder subscribes to, again determined at step 306, and communicate to them the funding request from the user with the user's identity, the item information, and if the user permitted, the funding time limit as well. Each communication is tailored by and subject to the restrictions the user has initially set or subsequently modified for the individual potential funders. Such restrictions may include restrictions on contents of messages to be sent with the request, on the price, type, or other information of the item(s) causing the funding request, and on whether the funding time limit is to be notified.

Funders may be informed of the request, with details as set forth herein, including a notification that if the item is not purchased, the fender's requested funds will not be used and will be returned to the funder if needed. Funders may also be notified that if the received funds from all responding funders exceeds the purchase price of the transaction, the funders' requested funds may be reduced in proportion to the excess funds received. In one example, a user is requesting to raise $100 from ten funders for the purchase of an item for $200. Each funder may be requested to contribute $20. If all ten agree to contribute, the user will have received $100 in excess. Then, each funder's actual contributions will be reduced to $10. If the funders are not requested to contribute a set amount, but are simply told that the user wishes to make a purchase of $200 and is trying to raise $100 from funders, two hinders may agree to contribute $40, and two funders may agree to contribute $20. That leaves $20 in excess. Then, the actual contribution from the first two funders will be reduced to $33.33 and the actual contribution from the other two funders will be reduced to $16.67.

Once the funding request and other accompanying information are communicated to the selected potential funders at step 310, the payment provider monitors the user's account during the funding time limit and communicates, at step 314, the status of the funds sent from any of the potential funders to the user over the user's device through suitable means such as text, email, or a voice message/call. The status may include not only current total funds in the user's account, including the user's own preexisting one, but the identities of the potential funders who sent the funds and individual amount of funds received from them.

In an embodiment, such communication of the status of the funds may occur at fixed time intervals during the funding time limit, or in another embodiment, whenever predetermined percentages of the total target fund have been reached. Or, in still another embodiment, the status of funds may be communicated to the user only when the target fund has been reached. As described hereinbefore, the funding time limit may be extended by the user and transmitted to the payment provider any time before the expiration of the initial user-set funding time limit, in which case, the payment provider may communicate the extended funding time limit to the potential funders, if not prohibited by a restriction set by the user, and/or accordingly extend the time for receiving funds in the user's account and communicating the status of funds to the user. On the other hand, the funding time limit can be cut short when the target fund in the user's account has been reached before the expiration of the initial user-set funding time limit. Once the funding is filled, the payment provider may send notifications to the potential funders that the requested funding amount has been reached. Alternatively, the payment provider may continue to receive funding up to the end of the funding time limit and then adjust the funding contributions as needed if the total received contributions exceed the user target amount as described hereinbefore via examples.

Once sufficient funds have filled the user's account, at step 316, the payment provider may receive a request to process payment for the item(s) according to the user-set preferred order. Accordingly, at step 318, the payment provider processes the payment transaction for the item(s) at issue according to payment option in the user's account information, if any.

FIG. 4 is a flowchart showing a process 400 a user performs, according to one embodiment, in making a purchase through the payment provider after sending a multi-cast request to the payment provider as described in the process 200. At step 402, the user receives a status of the funds from the payment provider. The status of the funds may be sent on the user's device, such as through text, email, or a voice message/call, and may include total funds in the user's account, the identities of senders, together with individual amount of received funds. The status may be communicated to the user at fixed time intervals during the user-set funding time limit, whenever predetermined percentages of the total fund in the user's account have been reached, or just one time either when the target amount of fund in the user's has been reached before the expiration of the funding time limit or when the funding time limit has expired without the target amount of the fund reached.

At step 404, the user may make a determination whether a sufficient fund has been reached in her or his account either at or before the expiration of the user-set funding time limit. That determination may be made from the user's own voluntary accessing and checking with the account via the user's device or from receiving the communication of the status of the funds from the payment provider. If there is not sufficient funds filled in the user's account even at the expiration of the user-set funding time limit, the user may, at step 406, determine whether the funding time limit should be extended. If the user determines to extend the funding time limit, then at step 408, the user transmits the extended time limit to the payment provider for it to extend the fund-receiving time and communicate to the selected potential funders such extension. The payment provider then communicates to the user the status of funds during the extended time at step 402. If the user determines not to, then the process 400 ends. Even if there is insufficient funds (e.g., the user target amount was not reached), the user may still decide to make the purchase by committing more funds from the user account (assuming the user has funds to commit or use).

If sufficient money was funded in the user's account at any time before the expiration of the funding time limit, the user transmits the purchase request, at step 410, to the payment provider to have it complete the purchase transaction via the user device. For example, on the user device, the user may select a “Purchase” or “Buy” button or link to request the payment provider to initiate the payment process or flow. If not already authenticated or logged in, the user may be asked to enter certain information, such as a user name, an email address, and/or a password/PIN. If partially authenticated, the user may only need to enter a password/PIN. In one embodiment, the user may have set a preference or instructions for the payment provider to automatically process the purchase transaction if the desired amount of funds is received.

In an online shopping setting, after a successful login or authentication, the user may be shown a checkout page on the user device for purchasing the item(s) the user desired to buy. If there is not sufficient fund gathered yet to purchase ‘all’ items, the user may designate the specific item(s) that she or he wishes to purchase with just the current amount of funds in the account at the checkout page. In one embodiment, the checkout page may be at the merchant's online site offering the selected item. In another embodiment, the checkout page may include all items in a single cart from different merchants, such as page hosted by the payment provider. The checkout page already has all information about the item(s) to be checked out since the item information has been previously transmitted to the payment provider.

An online checkout page may also include fields, either to be filled in or pre-filled, such as shipping address, billing address, etc. In one embodiment, because the payment provider knows user's account information, the shipping information may be automatically populated. The user may have the option of shipping the items to the user or directly to another recipient. Once all the requested fields have been completed, the payment may be processed by the payment provider, such as debiting an account of the user, debiting an account of one or more funders, and crediting an account of one or more sellers/merchants. A notification may be sent to the merchant, funders, and/or user of a successful payment. A notification may also be sent if the purchase is not made, such that funders who had agreed to fund a purchase are aware that their funds were not used.

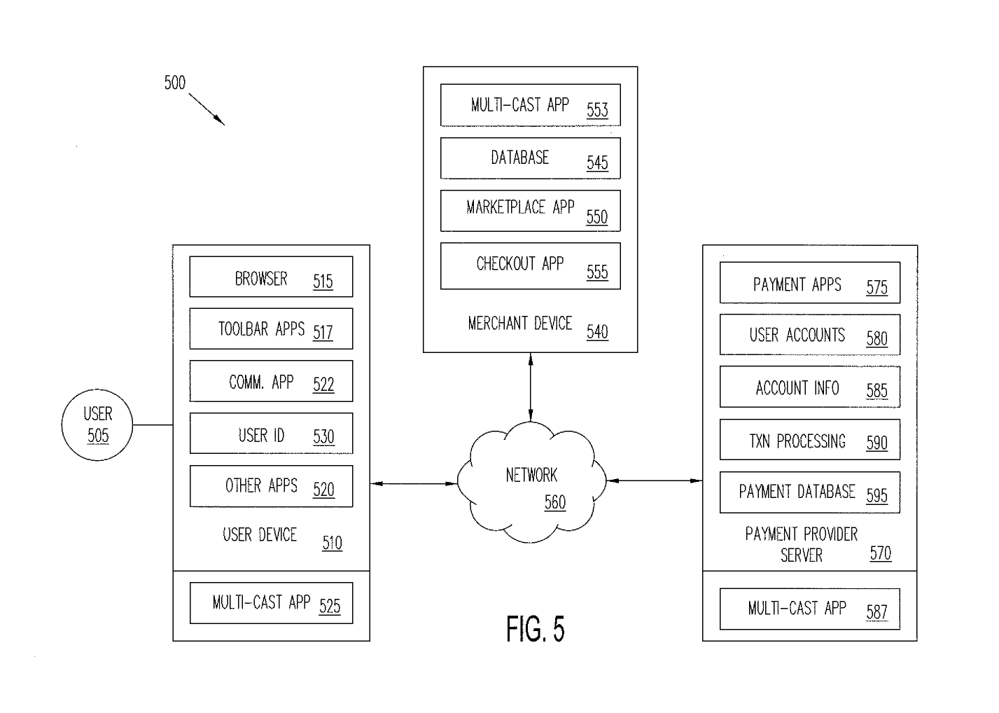

FIG. 5 is a block diagram of a networked system 500 configured to handle a transaction using a multi-casting funding method, such as described above, in accordance with an embodiment of the invention. System 500 includes a user device 510, a merchant server 540, and a payment provider server 570 in communication over a network 560. Payment provider server 570 may be maintained by a payment provider, such as PayPal, Inc. of San Jose, Calif. A user 505, such as a buyer or consumer, utilizes user device 510 to perform a purchase transaction using payment provider server 570. Note that transaction, as used herein, refers to any suitable action performed using the user device, including payments, transfer of information, display of information, etc. Although only one merchant server is shown, a plurality of merchant servers may be utilized if the user is purchasing commercial items from multiple merchants.

User device 510, merchant server 540, and payment provider server 570 may each include one or more processors, memories, and other appropriate components for executing instructions such as program code and/or data stored on one or more computer readable mediums to implement the various applications, data, and steps described herein. For example, such instructions may be stored in one or more computer readable media such as memories or data storage devices internal and/or external to various components of system 500, and/or accessible over network 560.

Network 560 may be implemented as a single network or a combination of multiple networks. For example, in various embodiments, network 560 may include the Internet or one or more intranets, landline networks, wireless networks, and/or other appropriate types of networks.

User device 510 may be implemented using any appropriate hardware and software configured for wired and/or wireless communication over network 560. For example, in one embodiment, the user device may be implemented as a personal computer (PC), a smart phone, personal digital assistant (PDA), laptop computer, tablet, and/or other types of computing devices capable of transmitting and/or receiving data, such as an iPad™ from Apple™.

User device 510 may include one or more browser applications 515 which may be used, for example, to provide a convenient interface to permit user 505 to browse information available over network 560. For example, in one embodiment, browser application 515 may be implemented as a web browser configured to view information available over the Internet, such as whether a particular person has subscribed to particular online social networks for setting up a funders' profile and/or merchant sites for viewing and purchasing commercial products. User device 510 may also include one or more toolbar applications 517 which may be used, for example, to provide client-side processing for performing desired tasks in response to operations selected by user 505. In one embodiment, toolbar application 517 may display a user interface in connection with browser application 515 as further described herein.

User device 510 may further include a multi-cast application 525 by which the user 505 may create or modify the funders' profile, which may be stored in the user device 510, payment provider server 570 via network 560, or both. To create the funders' profile, the multi-cast application 525 may enable the user 505 to enter: identifiers of potential funders such as names, an email addresses, mobile phone numbers, or other information that identifies the potential funders; any social network services the individual potential funders subscribe to; or restrictions to be placed in communicating a funding request to the potential funders. The types of restrictions to be entered into the funders' profile through the application may include: the kinds of items, price ranges of items, and names of sellers/merchants, for which the funding request should not be communicated to a particular potential funder; time zones of a year during which the funding request should not be communicated; messages to be communicated together with the funding request; or maximum amounts of funding individual particular potential funders can make in a month or a year.

The multi-cast application 525 may be directly linked to the user's account with the payment provider so that a user 505 may quickly access the account and check the balance in the account during shopping. It may be incorporated into the browser 515 in one embodiment such that it may be activated or populated by tapping or clicking a tab or button in the browser while the user 505 is shopping merchant's sites online. In another embodiment, especially applicable in an offline shopping situation, the multi-cast application 525 may be opened independently from a browser installed in the user device 510.

The multi-cast application 525 may enable the user 505 to transmit to the payment provider server 570: a multi-cast request; item information such as the identity, price, brand, manufacturer, seller/merchant, or even the picture of the item(s) that the user 505 desires to buy; a funding time limit that may be entered into the application by a suitable entry means provided by the application such as a touch screen, keyboard, keypad, or mouse; and any modifications to the previously created funders' profile.

The multi-cast application 525, whether incorporated into a browser on the user device 510 or loadable independently thereon, may enable the user 505 to make a multi-cast request to the payment provider server 570. In an online shopping setting using the user device 510, the functions of transmitting the multi-cast request, the item information of an item(s), the funding time limit, and any modifications to the funders' profile to the payment provider server 570 may be provided directly by the multi-cast application 525. In one embodiment, when the user 505 finds an item(s) for which the user 505 wishes to request funds during the online shopping, the user may tap or click on, say, a multi-cast request tab or button in the menu bar of the multi-cast application 525. Then the multi-cast application 525 may pop up a window requesting the user 505 to set a funding time limit by, for instance, selecting values in a menu or typing into a field.

The item information for the item(s) the user selected on the merchant's online shopping sites, which may be being viewed through the multi-cast application 525, may be scanned by the multi-cast application 525 and transmitted to the payment provider server 570 in one embodiment, or in another embodiment, transmitted directly from the merchant's server 560 to the payment provider server 570 without going through the multi-cast application 525 when the user 505 selects it.

The multi-east application 525 then may pop up another window with menus for the user 505 may modify any information in the funders' profile stored in either or both of the user device 510 and the payment provider server 570. Here, the user may modify the identifiers of potential funders, select only particular potential funders to communicate the funding request, select particular social network(s) through which the selected individual potential funders may be contacted, choose whether the item information should be communicated as well, restrict the types of item information to be transmitted, create/modify any messages to be communicated to individual potential funders, and so on.

In another embodiment for an online shopping setting, one or more of the multi-cast request, the item information of an item(s), and the funding time limit may be transmitted directly from the merchant server 540 to the payment provider server 570 without going through the user device 510 or the multi-cast application 525. In this embodiment, the merchant may be enabled to provide the transmission of one or more of the information. For instance, in one embodiment, there may be a “multi-cast” tab or button placed next to the items or a “multi-cast” bar in the menu bar in the merchant's shopping sites, and when the user 505 taps or clicks on it, the merchant site may pop up a window requesting the user 505 to enter an identifier for the user's account with the payment provider server 570, and set a funding time limit. Then the multi-cast request, the item information of an item(s), and the funding time limit may be transmitted, together with the user's identifier, directly from the merchant server 540 to the payment provider server 570 in this embodiment. Yet in another embodiment, the multi-cast request and the funding time limit may be made and set by the user 505 through the multi-cast application 525 and transmitted to the payment provider server 570 therefrom while only the item information may be directly transmitted to the payment provider server 570 from the merchant server 540.

In one embodiment, any modifications to the funders' profile by the user 505, if needed, may be performed and transmitted to the payment provider server 570 only at the user device 510 through the multi-cast application 525 installed therein.

In an offline merchant's store, the multi-cast application 525 may perform a similar functions as in the online shopping setting as described hereinbefore. When the user 505 finds a desirable item(s) on the store shelf, she or he may activate application on the user device 510, usually a handheld device such as mobile phones, iPod, or tablet in this situation, by which the user 505 may make the multi-cast request, set the funding time limit, and if needed, modify the funders' profile with any restriction(s) included therein, all to be transmitted to the payment provider server 570, according to one embodiment.

For transmitting the item information in an offline merchant's store, there may be several different ways. When the user device 510 has a scanner, the item information may be obtained from scanning the barcode of the item on a shelf and transmitted by the multi-cast application 525 in an embodiment. When the user device 510 has no scanner, user 505 may type, this time, only selected kinds of the item information into the multi-cast application 525 using a suitable data entry means provided by the application such as touch screen menus or keypad, according to an embodiment.

In another embodiment, the item information may be directly transmitted from a merchant server 540 when the user 505 presses a “multi-cast” button placed next to or below the item on the shelf. In this embodiment, the merchant server 540 may provide the service of transmitting the multi-cast request and setting up/transmitting the funding time limit as well. When the user 505 presses the “multi-cast” button, a small device located next to the button/item may pop up a window on its screen requesting the user 505 to enter an identifier for the user's account with the payment provider server 570 by either entering the user's account ID 530 or swiping/scanning a user's identifier card such as Safeway card into the store device. After then, the store device may further ask the user 505 to set a funding time limit When finished, the multi-cast request, the item information of an item(s) selected, and the funding time limit may be transmitted, together with the user's account identifier, directly from the merchant server 540 to the payment provider server 570. In this case, still any modifications to the funders' profile may be made using the multi-cast application 525, if the user 505 wishes, and transmitted to the payment provider server 570 from the user device 510.

User device 510 may further include other applications 520 as may be desired in particular embodiments to provide desired features to user device 510. For example, other applications 520 may include security applications for implementing client-side security features, programmatic client applications for interfacing with appropriate application programming interfaces (APIs) over network 560, or other types of applications. Applications 520 may also include email, texting, voice and IM applications that allow user 505 to send and receive emails, calls, and texts through network 560, as well as applications that enable the user 505 to communicate, transfer information, and make payments. User device 510 includes one or more user identifiers 530 which may be implemented, for example, as operating system registry entries, cookies associated with browser application 515, identifiers associated with hardware of user device 510, or other appropriate identifiers, such as used for payment/user/device authentication. In one embodiment, user identifier 530 may be used by a payment service provider to associate user 505 with a particular account maintained by the payment provider as further described herein. A communications application 522, with associated interfaces, enables user device 510 to communicate within system 500.

Merchant server 540 may be maintained, for example, by a merchant or seller offering various products and/or services in exchange for payment to be received over network 560. Merchant server 540 may be used for POS or online purchases and transactions. Generally, merchant server 540 may be maintained by anyone or any entity that receives money, which includes charities as well as retailers and restaurants. For example, an purchased item may be a donation to charity in the name of the user 505. Merchant server 540 includes a database 545 identifying available products and/or services (e.g., collectively referred to as items) which may be made available for viewing and purchase by user 505. Accordingly, merchant server 540 also includes a marketplace application 550 which may be configured to serve information over network 560 to browser 515 of user device 510. In one embodiment, user 505 may interact with marketplace application 550 through browser applications over network 560 in order to view various products, food items, or services identified in database 545.

Further, the merchant server 540 may further include a multi-cast application 553, which may be either incorporated into the marketplace application 550 or separate but linked with the marketplace application 550, for the purpose of providing the service of transmitting a multi-cast request with other necessary data to the payment provider server 570 on behalf of the user 505. In one embodiment, the multi-cast application 553 is activated when the user 505 taps or clicks on a “multi-cast” tab or button provided either on the merchant's shopping webpage or next to the shelved item in the merchant's offline store. When activated, the multi-cast application 553 may enable the user 505 to set the funding time limit through a menu bar or field to fill in on the merchant's website or through a separate device placed next to the item in the merchant's store. The multi-cast application 553 may further request the user's identifier for having the user 505 identified to the payment provider server 570. In online setting, the multi-cast application 553 may require the user 505 to enter the user's ID number, and in an offline shopping setting, the multi-cast application 553 may require the user 505 to swipe/scan a user's identifier card such as Safeway card into the store provided device. When all the required data are entered, the multi-cast application 553 transmits the multi-cast request, the item information of an item(s) selected, the funding time limit, and the user's account identifier, directly to the payment provider server 570.

Merchant server 540 also includes a checkout application 555 which may be configured to facilitate the purchase by user 505 of goods or services identified by marketplace application 550. Checkout application 555 may be configured to accept payment information from or on behalf of user 505 through payment service provider server 570 over network 560. For example, checkout application 555 may receive and process a payment confirmation from payment service provider server 570, as well as transmit transaction information to the payment provider and receive information from the payment provider (e.g., a transaction ID).

Payment provider server 570 may be maintained, for example, by an online payment service provider which may provide payment between user 505 and the operator of merchant server 540. In this regard, payment provider server 570 includes one or more payment applications 575 which may be configured to interact with user device 510 and/or merchant server 540 over network 560 to facilitate the purchase of goods or services, communicate/display information, and send payments by user 505 of user device 510 and as discussed above.

Payment provider server 570 also maintains a plurality of user accounts 580, each of which may include account information 585 associated with individual users, including funders' profile created by the user 505. For example, account information 585 may include private financial information of users of devices such as account numbers, passwords, device identifiers, user names, phone numbers, credit card information, bank information, or other financial information, and shipping information which may be used to facilitate online transactions by user 505. Account information may also include user purchase history. Advantageously, payment application 575 may be configured to interact with merchant server 540 on behalf of user 505 during a transaction with checkout application 555 to track and manage purchases made by users and which funding sources are used, as well as incentives for a user.

Payment provider server 570 may further include a multi-cast application 587, which assists the user 505 to procure a sufficient fund for purchasing products via multi-cast funding request to potential funders. The multi-cast application 587 may enable a user to set up/modify a funders' profile as described hereinbefore, through an application in a user's device 510, and once done, it may associate the funders' profile with the user's account information 585. The multi-cast application 587 may receive from the user 505 a multi-cast request, any modifications to the funders' profile, item information about an item a user desires to purchase, and a funding time limit, and update the funders' profile if it is modified. The multi-cast application 587 may communicate the funding request, the item information and the funding time limit to the potential funders based on the funders' profile with all the restrictions contained therein and on the any modifications thereof. The multi-cast application 587 may receive such multi-cast request, any modifications to the funders' profile, item information and funding time limit from either the user device 510 or the merchant device 540 as described hereinbefore.

The multi-cast application 587 may monitor the status of funds transmitted from the potential funders to the user's account, and communicate to the user 505 on a user device 510 the status of the funds transmitted to the user's account at preset intervals the user 505 determines.

The multi-cast application 587 may also check and determine whether each of the potential funders, to whom the funding request is to be communicated, has a valid account with a payment provider by accessing user accounts 580, and if any of the potential funders does not have a valid account, it may contact such potential funder(s) to request permission and appropriate information to create a new account or reactivate an invalid account, and thereafter create or reactivate accounts upon their permission.

The transaction processing application 590, which may be part of payment application 575 or separate, may be configured to receive a purchase request from a user device 510 and/or merchant server 540 for processing payment and storing the transaction in a payment database 595. In an embodiment, such purchase request may come to the transaction processing application 590 through the multi-cast application 525 in the user's device 510, the multi-cast application 553 in the merchant device 540, or the multi-cast application 587 in the payment provider server 570. The transaction processing application 590 may include one or more applications to process information from user 505 for processing an order and payment using various selected funding instruments as described herein. As such, transaction processing application 590 may store details of an order associated with a phrase from individual users. Payment application 575 may be further configured to determine the existence of and to manage accounts for user 505, as well as create new accounts if necessary, such as the set up, management, and use of funders' profile for users as discussed herein.

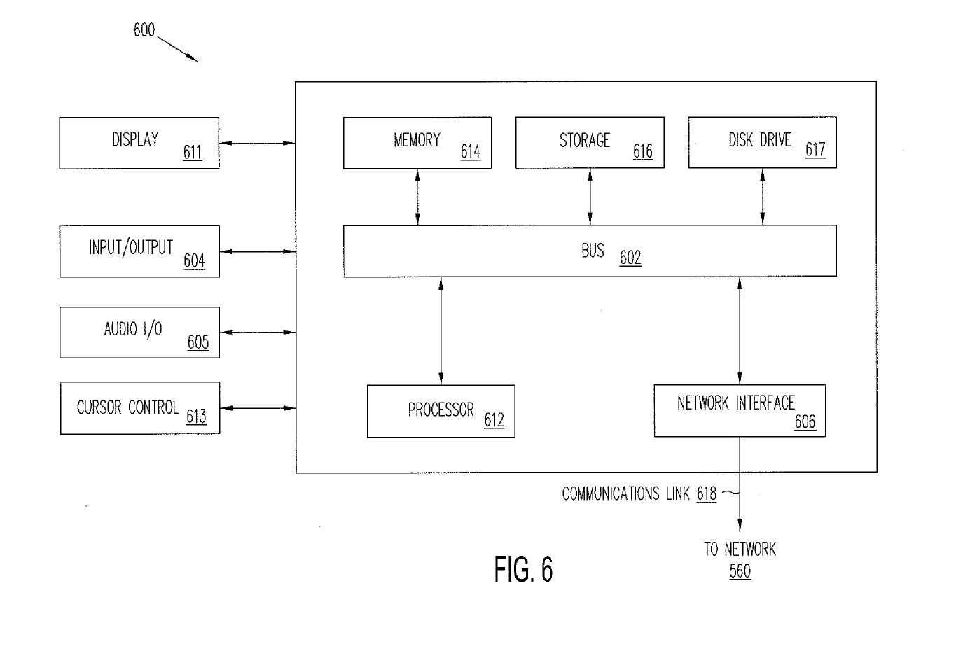

FIG. 6 is a block diagram of a computer system 600 suitable for implementing one or more embodiments of the present disclosure. In various implementations, the user device may comprise a personal computing device (e.g., smart phone, a computing tablet, a personal computer, laptop, PDA, Bluetooth device, key FOB, badge, etc.) capable of communicating with the network. The merchant and/or payment provider may utilize a network computing device (e.g., a network server) capable of communicating with the network. It should be appreciated that each of the devices utilized by users, merchants, and payment providers may be implemented as computer system 600 in a manner as follows.

Computer system 600 includes a bus 602 or other communication mechanism for communicating information data, signals, and information between various components of computer system 600. Components include an input/output (I/O) component 604 that processes a user action, such as selecting keys from a keypad/keyboard, selecting one or more buttons or links, etc., and sends a corresponding signal to bus 602. I/O component 604 may also include an output component, such as a display 611 and a cursor control 613 (such as a keyboard, keypad, mouse, etc.). An optional audio input/output component 605 may also be included to allow a user to use voice for inputting information by converting audio signals. Audio I/O component 605 may allow the user to hear audio. A transceiver or network interface 606 transmits and receives signals between computer system 600 and other devices, such as another user device, a merchant server, or a payment provider server via network 560. In one embodiment, the transmission is wireless, although other transmission mediums and methods may also be suitable. A processor 612, which can be a micro-controller, digital signal processor (DSP), or other processing component, processes these various signals, such as for display on computer system 600 or transmission to other devices via a communication link 618. Processor 612 may also control transmission of information, such as cookies or IP addresses, to other devices.

Components of computer system 600 also include a system memory component 614 (e.g., RAM), a static storage component 616 (e.g., ROM), and/or a disk drive 617. Computer system 600 performs specific operations by processor 612 and other components by executing one or more sequences of instructions contained in system memory component 614. Logic may be encoded in a computer readable medium, which may refer to any medium that participates in providing instructions to processor 612 for execution. Such a medium may take many forms, including but not limited to, non-volatile media, volatile media, and transmission media. In various implementations, non-volatile media includes optical or magnetic disks, volatile media includes dynamic memory, such as system memory component 614, and transmission media includes coaxial cables, copper wire, and fiber optics, including wires that comprise bus 602. In one embodiment, the logic is encoded in non-transitory computer readable medium. In one example, transmission media may take the form of acoustic or light waves, such as those generated during radio wave, optical, and infrared data communications.

Some common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EEPROM, FLASH-EEPROM, any other memory chip or cartridge, or any other medium from which a computer is adapted to read.

In various embodiments of the present disclosure, execution of instruction sequences to practice the present disclosure may be performed by computer system 600. In various other embodiments of the present disclosure, a plurality of computer systems 600 coupled by communication link 618 to the network (e.g., such as a LAN, WLAN, PTSN, and/or various other wired or wireless networks, including telecommunications, mobile, and cellular phone networks) may perform instruction sequences to practice the present disclosure in coordination with one another.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, persons of ordinary skill in the art will recognize that changes may be made in form and detail without departing from the scope of the present disclosure. Thus, the present disclosure is limited only by the claims.

1. A system comprising:
a memory storing account information for a user, wherein the account information comprises a funders' profile that comprises identifiers of potential funders, any user-created restrictions on the potential funders, or contact channels comprising social network services the potential funders subscribe to;
one or more processors in communication with the memory, the one or more processors being configured to:
receive from the user a multi-cast request, any modifications to the funders' profile, item information about an item the user desires to purchase, and a funding time limit set by the user for receiving funds from the potential funders;
communicate a funding request to the potential funders based on the funders' profile and on the any modifications thereof; and
communicate to the user on a user device status of the funds transmitted to an account of the user from the potential funders.

2. The system of claim 1, wherein the one or more processors is further configured to communicate to the potential funders the item information and the funding time limit.

3. The system of claim 1, wherein the multi-cast request, the any modifications to the funders' profile, the item information, and the funding time limit are transmitted via the user device.

4. The system of claim 3, wherein the item information is scanned into the user device.

5. The system of claim 1, wherein the item information is transmitted to the one or more processors via a merchant device.

6. The system of claim 5, wherein the multi-cast request and the funding time limit are transmitted to the one or more processors via the merchant device from an initiation of the user.

7. The system of claim 1, wherein the one or more processors is further configured to process a payment for the item at the user's request.

8. The system of claim 1, wherein the one or more processors is further configured to adjust actual individual contributions from the potential funders who have responded to the funding request if the total funds received therefrom exceed a target amount set by the user.

9. A method for performing a transaction using a user device, comprising:
receiving, by one or more processors of a service provider from a user, a multi-cast request to communicate a funding request to potential funders for purchasing an item, item information about the item, and a funding time limit set by the user for receiving funds from the potential funders;
communicating, by the one or more processors, the funding request to the potential funders based on a funders' profile stored in a memory of the service provider and on any modifications thereof wherein the funders' profile comprises identifiers of the potential funders, any user-created restrictions on the potential funders, and contact channels comprising social network services the potential funders subscribe to; and
communicating, by the one or more processors, to the user on the user device status of the funds transmitted to an account of the user from the potential funders.

10. The method of claim 9, further comprising communicating, by the one or more processors, to the potential funders the item information and the funding time limit.

11. The method of claim 9, wherein the multi-cast request, the any modifications to the funders' profile, the item information, and the funding time limit are transmitted via the user device.

12. The method of claim 11, wherein the item information is scanned into the user device.

13. The method of claim 9, wherein the item information is transmitted to the one or more processors via a merchant device.

14. The method of claim 13, wherein the multi-cast request and the funding time limit are transmitted to the one or more processors via the merchant device from an initiation of the user.

15. The method of claim 9, further comprising processing, by the one or more processor, a payment for the item at the user's request.

16. The method of claim 9, further comprising adjusting actual individual contributions from the potential funders who have responded to the funding request if the total funds received therefrom exceed a target amount set by the user.

17. A non-transitory machine-readable medium comprising a plurality of machine-readable instructions which, when executed by one or more processors of a server, are adapted to cause the server to perform a method comprising:
receiving, by the one or more processor of the server, from a user a multi-cast request to communicate a funding request to potential funders for purchasing an item, item information about the item, and a funding time limit set by the user for receiving funds from the potential funders;
communicating, by the one or more processor, the funding request to the potential funders based on a funders' profile stored in a memory of the server and on any modifications thereof wherein the funders' profile comprises identifiers of the potential funders, any user-created restrictions on the potential funders, and contact channels comprising social network services the potential funders subscribe to; and
communicating, by the one or more processor, to the user a the user device status of the funds transmitted to an account of the user with a payment provider from the potential funders.

18. The non-transitory machine-readable medium of claim 17, wherein the method further comprises communicating, by the one or more processor, to the potential funders the item information and the funding time limit.

19. The non-transitory machine-readable medium of claim 17, wherein the multi-cast request, the any modifications to the funders' profile, the item information, and the funding time limit are transmitted via the user device.

20. The non-transitory machine-readable medium of claim 19, wherein the item information is scanned into the user device.

21. The non-transitory machine-readable medium of claim 17, wherein the item information is transmitted to the one or more processors via a merchant device.

22. The non-transitory machine-readable medium of claim 21, wherein the multi-cast request and the funding time limit are transmitted to the one or more processors via the merchant device from an initiation of the user.

23. The non-transitory machine-readable medium of claim 17, wherein the method further comprises processing, by the one or more processor, a payment for the item at the user's request.

24. The non-transitory machine-readable medium of claim 17, wherein the method further comprises adjusting actual individual contributions from the potential funders who have responded to the funding request if the total funds received therefrom exceed a target amount set by the user.
